(19) United States
(12) Patent Application Publication
(10) Pub. No.: US 2018/0189144 A1
(43) Pub. Date: Jul. 5, 2018

(54) APPARATUS AND METHOD FOR MEMORY STORAGE TO PROTECT DATA-LOSS AFTER POWER LOSS

(71) Applicant: IUCF-HYU (INDUSTRY-UNIVERSITY COOPERATION FOUNDATION HANYANG UNIVERSITY), Seoul (KR)

(72) Inventors: Yong Ho SONG, Seongnam-si (KR); Sang Hyuk JUNG, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 15/736,607

(22) PCT Filed: Jun. 16, 2016
(86) PCT No.: PCT/KR2016/006392

§ 371 Date: Dec. 14, 2017

(30) Foreign Application Priority Data
Jun. 16, 2015 (KR) 10-2015-0085378
Jun. 29, 2015 (KR) 10-2015-0092405
Jun. 29, 2015 (KR) 10-2015-0092407

(51) Int. Cl. G06F 11/14; G06F 12/0864; G06F 11/07

(52) U.S. Cl. CPC G06F 11/1451; G06F 12/0864; G06F 2212/1032; G06F 11/0727; G06F 2212/608; G06F 11/1458

(57) ABSTRACT

Disclosed are a memory storing apparatus and method for preventing data loss after power loss. A memory storing method includes: determining a plurality of first user blocks scheduled to write data among a plurality of user blocks in which data is written, based on a recovery time of a mapping table required by a user; writing data in the determined first user blocks; writing a first mapping table in a spare area and a last page of the first user blocks in which the data is written; and switching the first user blocks written in the system page into second user blocks in which the data is completely written when data is written in all the first user blocks and writing a second mapping table for the switched second user blocks in a map page of a map block.

### TECHNICAL FIELD

The present invention relates to a memory storing apparatus and method to prevent data loss after power loss and more particularly, to an apparatus and a method for storing a memory using a system page in which writing order information for user blocks which are scheduled to write data among a plurality of user blocks in which data will be written.

### BACKGROUND ART

Recently, a flash memory based storage apparatus are becoming popular as a major storage medium of a mobile system or a personal portable computer system. The flash memory based storage apparatus is expected to be consistently used as a next generation storage medium which replaces an existing hard disk.

However, the flash memory has many disadvantages depending on characteristics of a semiconductor device which configures the flash memory so that a mechanism which effectively analyzes and resolves the disadvantages is necessary. To this end, the flash memory based storage apparatus compensates the disadvantages of the installed flash memory using a controller. The disadvantage of the flash memory is that overwrite is not allowed and a number of erasing times is limited. Therefore, in order to overcome the above-mentioned disadvantages and provide an interface like the existing hard disk, a mapping technique for flexibly accessing an area of the flash memory in which data is stored is required. Since the mapping table is frequently changed and needs to be quickly accessed, the mapping table is stored in a volatile memory such as an SRAM or a DRAM in addition to the flash memory.

The volatile memory such as an SRAM or a DRAM has a problem in that stored data is evaporated at the time of power loss. In order to solve the above-mentioned problem, the flash memory based storage apparatus needs to use a technique of entirely or partially storing a mapping table stored in the volatile memory such as the SRAM or the DRAM, in a separate flash memory.

In this case, when the mapping table is too frequently stored in the flash memory, a large additional storage space for processing the mapping table needs to be secured and a delay time is long. Therefore, the performance of the flash memory based storage apparatus may be deteriorated. A rebooting time after the power loss is taken to inspect a storage area and restore the mapping table to recover to a state before the power loss. However, the rebooting time needs to be managed such that only the delay which is acceptable by the user occurs. Consequently, a trade-off relationship is established between a storage frequency of the mapping table and the rebooting time after the power loss and a method for managing the trade-off relationship between the storage frequency and the rebooting time to be balanced is required.

However, the techniques of the related art are not manufactured based on accurate analysis of a trade-off relationship between the storage frequency of the mapping table and the rebooting time after the power loss. Further, in order to search a user block used at last at the time of rebooting after the power loss, very long delay time is caused.

### DISCLOSURE

### Technical Problem

An object of the present invention is to provide a memory storing apparatus and method to prevent data loss after power loss and to provide an apparatus and a method for recovering a mapping table by quickly finding a user block used immediately before the abnormal termination using a system page in which writing order information for a user blocks which are scheduled to write data among a plurality of user blocks in which data will be written.

### Technical Solution

According to an exemplary embodiment of the present invention, a memory storing method includes: determining a plurality of first user blocks scheduled to write data among a plurality of user blocks in which data will be written, based on a recovery time of a mapping table required by a user; storing writing order information for the determined first user blocks in a system page of a system block; writing data in first user blocks corresponding to the writing order information; writing a first mapping table in a spare area and a last page of the first user blocks in which the data is written; and switching the first user blocks written in the system page into second user blocks in which the data is completely written when data is written in all the first user blocks and writing a second mapping table for the switched second user blocks in a map page of a map block.

In the determining, the number of first user blocks which satisfies the recovery time of the mapping table required by the user may be determined using a recovery time for the first mapping table written in the first user blocks and a recovery time for the second mapping table written in the map block.

The writing of data in the first user blocks may include: identifying whether the data has a temporal locality or a spatial locality when data scheduled to be written in the first user blocks is transmitted through a host system and writing the data in the first user blocks based on the identified locality of data.

In the identifying, when the data needs to be repeatedly written in a specific logical address during a predetermined time interval, it is identified that the data has a temporal locality; and when the data needs to be written in a similar logical address area, it is identified that the data has a spatial locality.

In the writing of the data in the first user blocks based on the identified locality of data, when it is identified that the data has the spatial locality, the data may be sequentially written in a plurality of pages included in any one user block among the plurality of user blocks.

In the writing of the data in the first user blocks based on the identified locality of data, when it is identified that the data has the temporal locality, the data may be collectively written in any one user block among the plurality of user blocks.

In the writing of the data in the first user blocks based on the identified locality of data, when it is identified that the data has a spatial locality, the data may be divided according to a multi-process or a multi-thread of a host system and the divided data may be collectively written in any one user block among the plurality of user blocks according to a process unit or a thread unit.

According to another exemplary embodiment of the present invention, a memory recovering method includes: identifying a map block which is used immediately before abnormal power loss, among a plurality of map blocks; recovering a second mapping table stored in a map page of the identified map block to a cache memory; determining a system block used immediately before the abnormal power loss, among a plurality of system blocks; and updating a first mapping table using information on first user blocks stored in a system page of the determined system block.

In the identifying, the map block which is used immediately before the abnormal power loss may be identified using first page information and last page information of each of the plurality of map blocks.

The first page information of each of the plurality of map blocks may include allocating order information of the map block at the time of allocating and using the map block, and the last page information of each of the plurality of map blocks may include information for identifying whether the map block is deleted when all the pages of the map block are used.

In the determining, the system block which is used immediately before the abnormal power loss may be determined using first page information and last page information of each of the plurality of system blocks.

The first page information of the plurality of system blocks may include allocating order information of the system block at the time of allocating and using the system block, and the last page information of each of the plurality of system blocks may include information for identifying whether the system block is deleted when all the pages of the system block are used.

In the updating, when data is written in all pages of the first user block among the first user blocks stored in the identified system block, the first mapping table may be recovered to a cache memory using the last page of the first user block and when data is not written in all pages of the first user block, the first mapping table may be recovered to the cache memory using a spare area of the first user block.

According to another exemplary embodiment of the present invention, a memory storage apparatus includes a controller which performs a plurality of operations, in which the plurality of operations includes: an operation of determining a plurality of first user blocks scheduled to write data among a plurality of user blocks in which data will be written, based on a recovery time of a mapping table required by a user; an operation of storing writing order information for the determined first user blocks in a system page of a system block; an operation of writing data in first user blocks corresponding to the writing order information; an operation of writing a first mapping table in a spare area and a last page of the first user blocks in which the data is written; and an operation of switching the first user blocks written in the system page into second user blocks in which the data is completely written when data is written in all the first user blocks and writing a second mapping table for the switched second user blocks in a map page of a map block.

The controller may determine the number of first user blocks which satisfies the recovery time of the mapping table required by the user using a recovery time for the first mapping table written in the first user blocks and a recovery time for the second mapping table written in the map block.

When the data scheduled to be written in the first user blocks is transmitted through a host system, the controller may identify whether the data has a temporal locality or a spatial locality and writes the data in the first user blocks based on the identified locality of data.

When the data needs to be repeatedly written in a specific logical address during a predetermined time interval, the controller may identify that the data has a temporal locality and when the data needs to be written in a similar logical address area, the controller may identify that the data has a spatial locality.

When it is identified that the data has the spatial locality, the controller may sequentially write the data in a plurality of pages included in any one user block among the plurality of user blocks.

When it is identified that the data has the temporal locality, the controller may collectively write data in any one user block among the plurality of user blocks.

When it is identified that the data has a spatial locality, the controller may divide the data according to a multi-process or a multi-thread of a host system and collectively write the divided data in any one user block among the plurality of user blocks according to a process unit or a thread unit.

Another exemplary embodiment of the present invention, a memory recovering apparatus includes a controller which performs a plurality of operations, in which the plurality of operations includes: an operation of identifying a map block which is used immediately before abnormal power loss, among a plurality of map blocks; an operation of recovering a second mapping table stored in a map page of the identified map block to a cache memory; an operation of determining a system block used immediately before the abnormal power loss, among a plurality of system blocks; and an operation of updating a first mapping table using information on first user blocks stored in a system page of the determined system block.

The controller may identify the map block which is used immediately before the abnormal power loss using first page information and last page information of each of the plurality of map blocks.

The first page information of each of the plurality of map blocks may include allocating order information of the map block at the time of allocating and using the map block, and the last page information of each of the plurality of map blocks may include information for identifying whether the map block is deleted when all the pages of the map block are used.

The controller may identify the system block which is used immediately before the abnormal termination using first page information and last page information of each of the plurality of system blocks.

The first page information of each of the plurality of system blocks may include allocating order information of the system block at the time of allocating and using the system block, and the last page information of each of the plurality of system blocks may include information for identifying whether the system block is deleted when all the pages of the system block are used.

When data is written in all pages of the first user block among the first user blocks stored in the identified system block, the controller may recover the first mapping table to a cache memory using the last page of the first user block and when data is not written in all pages of the first user block, the controller may recover the first mapping table to the cache memory using a spare area of the first user block.

### Advantageous Effects

According to the exemplary embodiment of the present invention, the system page in which writing order information for the user blocks scheduled to write data among the plurality of user blocks in which data will be written is stored is used so that the user block used immediately before the abnormal termination is quickly found to recover the mapping table.

According to the exemplary embodiment of the present invention, the number of user blocks which satisfy a recovery time of the mapping table required by the user is determined so that a storing time of the map table may be flexibly adjusted.

According to the exemplary embodiment of the present invention, the temporal locality or the spatial locality of the data is identified and the data is written in the user block based on the identified locality, so that the performance and the durability of the storage apparatus may be improved.

### DESCRIPTION OF DRAWINGS

FIG. 1 is a view illustrating a memory storage apparatus according to an exemplary embodiment of the present invention.

FIG. 2 is a view illustrating a structure of a flash memory according to an exemplary embodiment of the present invention.

FIG. 3 is a view illustrating a data block in a flash memory according to an exemplary embodiment of the present invention.

FIG. 4 is a view illustrating a configuration of a system page according to an exemplary embodiment of the present invention.

FIG. 5 is a view illustrating a memory managing method according to an exemplary embodiment of the present invention.

FIG. 6 is a view illustrating a method for determining a number of first user blocks according to an exemplary embodiment of the present invention.

FIG. 7 is a view illustrating the number of user blocks which can be recovered for every recovery time of a mapping table required by a user according to an exemplary embodiment of the present invention.

FIG. 8 illustrates a method of storing data to be divided in a related open block, according to an exemplary embodiment of the present invention.

FIG. 9 illustrates a method of writing data in an open block according to an exemplary embodiment of the present invention.

FIG. 10 illustrates a method of writing data in an open block managed by a system page according to an exemplary embodiment of the present invention.

FIG. 11 is a view illustrating a mapping table writing method according to an exemplary embodiment of the present invention.

FIG. 12 is a view illustrating a mapping table recovering method according to an exemplary embodiment of the present invention.

[Description of Main Reference Numerals of Drawings]

| | |
|---|---|
| 100: Memory storage apparatus | 110: Controller |
| 120: Cache memory | 130: Flash memory |
| 210: System block area | 220: Map block area |
| 230: User block area | 300: User block |
| 310: Data area | 320: Spare area |
| 330: Last page | 400: System page |
| 410: First user block list | 420: Second user block list |
| 430: Third user block list | 440: Map block list |

### BEST MODE

Hereinafter, exemplary embodiments of the present invention will be described in detail with reference to the accompanying drawings.

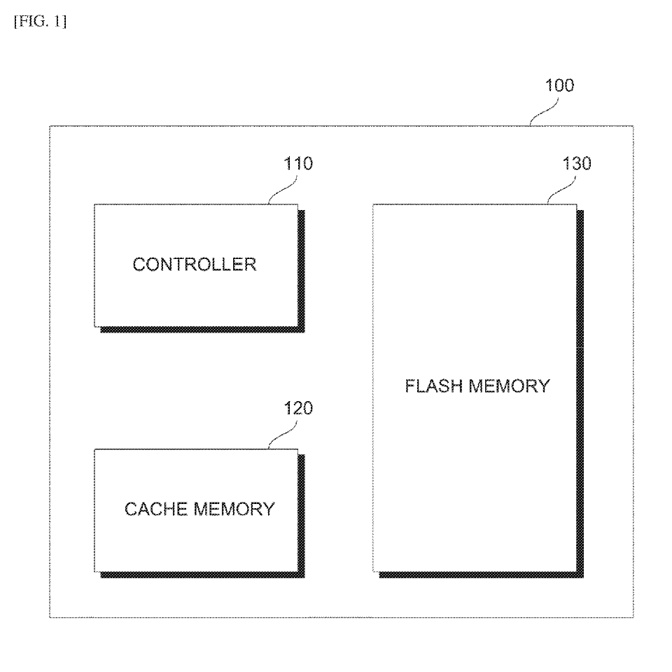

FIG. 1 is a view illustrating a memory storage apparatus according to an exemplary embodiment of the present invention.

A memory storage apparatus 100 may be configured by a controller 110, a cache memory 120, and a flash memory 130. The controller 110 may store data in the flash memory 130 or read and delete the stored data. In the present invention, the controller 110 provides a method of storing data in the flash memory 130 using a system page and quickly recovering the mapping table after abnormal power loss. In this case, in the system page, writing order information for user blocks scheduled to write data among a plurality of user blocks in which data will be written may be stored.

Further, in the present invention, the controller 110 identifies whether data transmitted through a host system has a temporal locality or a spatial locality and then writes the data in a user block in the flash memory 130 based on the identified locality.

Further, in the present invention, the controller 130 provides a method of storing data in the flash memory 130 using a system page and quickly recovering the mapping table after abnormal power loss. In this case, in the system page, writing order information for first user blocks scheduled to write data among a plurality of user blocks in which the data will be written may be stored. The first user blocks may be determined based on a recovery time of the mapping table required by the user. Details will be described with reference the following drawings.

The cache memory 120 may store the mapping table. The mapping table needs to be frequently changed whenever the input data is stored in the flash memory and needs to be quickly accessed. Therefore, the mapping table may be stored in the volatile memory such as the SRAM or DRAM. However, the volatile memory may have a problem in that the data stored in the memory may be evaporated when the power is lost. Therefore, the mapping table stored in the cache memory 120 needs to be entirely stored in a separate flash memory 130 or a changed part needs to be separately stored in the separate flash memory 130.

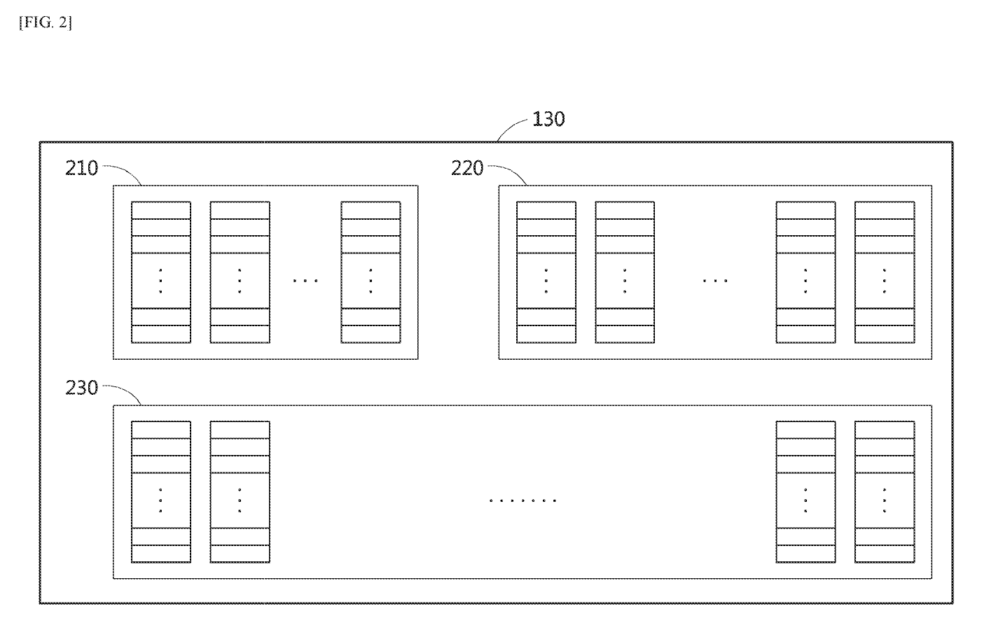

The flash memory 130 may be configured by a plurality of data blocks. Each data block may be configured by a plurality of pages and data may be stored in each page. The data block may be represented as a system block, a map block, and a user block according to information stored in a page of the data block. A detailed configuration of the flash memory 130 will be described with reference to FIG. 2.

FIG. 2 is a view illustrating a structure of a flash memory according to an exemplary embodiment of the present invention.

The flash memory 130 may be configured by a plurality of data blocks. In this case, the data block in which a system page is stored is defined as a system block and a data block in which a mapping table is stored may be defined as a map block. Further, a data block in which input data is stored may be defined as a user block. The flash memory 130 may be configured by a system block area 210 configured by a plurality of system blocks, a map block area 220 configured by map blocks, and a user block area 230 configured by user blocks.

The system block in the system block area 210 may store a system page. The system page may include writing order information on user block scheduled to be written among a plurality of user blocks in which data will be written. The controller 110 uses the system page to quickly find a user block which is used immediately before abnormal termination so that a time to recover a mapping table after the power loss may be shortened. The controller 110 may identify a map block in which the mapping table is stored and a user block which is being used immediately before the abnormal termination to recover the mapping table after abnormal power loss. In this case, the map block and the user block which are being used immediately before abnormal termination may be identified by identifying information for identifying an allocating order stored in a first page of the map blocks and the user blocks and whether to delete the corresponding map blocks and the user blocks stored in the last page.

The map blocks in the map block area 220 may store the mapping table. The mapping table may be generated through a flash translation layer in the controller 110. The flash translation layer may translate a logical address of data into a physical address for a physical data block in the flash memory 130 and the page to connect the logical address and the physical address with each other. The mapping table needs to be frequently changed whenever the data is stored in the flash memory and needs to be quickly accessed. Therefore, the mapping table may be stored in the cache memory such as the SRAM or DRAM. However, the cache memory such as the SRAM or the DRAM has a problem in that stored data is evaporated when the power is lost. Therefore, the controller 110 needs to store the entire mapping table stored in the cache memory 120 in the flash memory 130 or separate a changed part of the mapping table to store the changed part in a map block of the flash memory 130 according to a separate method.

The user block in the user block area 230 may store data. The user block may be configured by a plurality of pages and data may be sequentially stored in the plurality of pages.

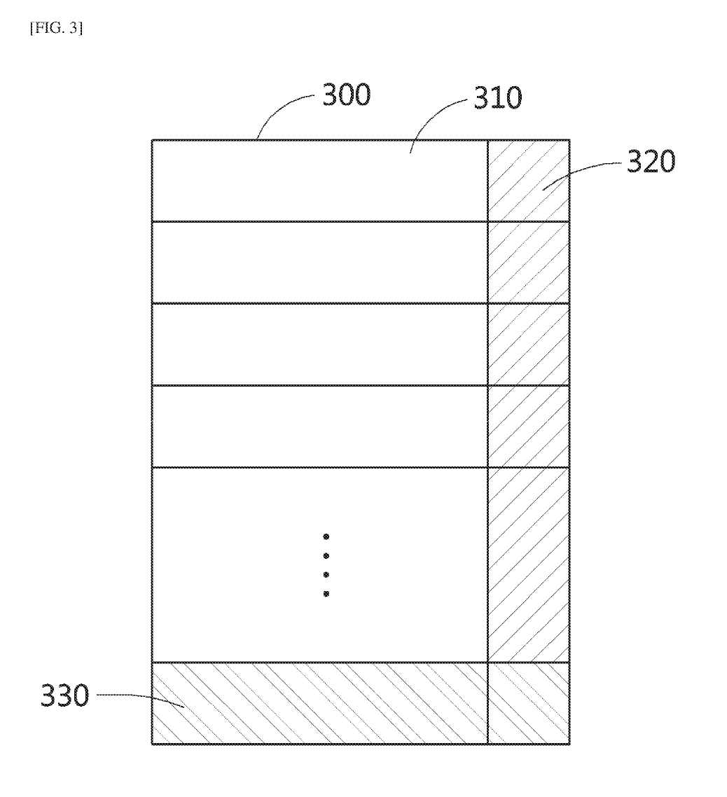

FIG. 3 is a view illustrating a data block in a flash memory according to an exemplary embodiment of the present invention.

The data block 300 may be configured by a plurality of pages. One page may be divided into a data area 310 and a spare area 320. In the data area 310, data may be stored. In the spare area 320, a mapping table for the corresponding page, an error correction code (ECC), and the like may be stored. For example, in the data area of the data block 300, which configures a page of the map block, data for a mapping table of data currently existing in the flash memory 130 is stored. Further, in the spare area, a mapping table for the page of the corresponding map block and the error correction code may be stored. Alternatively, data may be stored in the data area of the data block 300 which configures the page of the user block and the mapping table for the page of the corresponding user block and the error correction code may be stored in the spare area.

The data block 300 is allocated by the controller 110 to store an input data and store the allocating order in the first page of the corresponding data block at the time of being used. The data may be sequentially stored from the first page of the data block to the last page. In the last page 330, a mapping table stored in the spare area 320 of each of all the pages included in the corresponding data block 300 may be stored. In this case, when all the pages of the corresponding data block is used, the data block 300 may include information for identifying whether to delete the data block, in the last page 330.

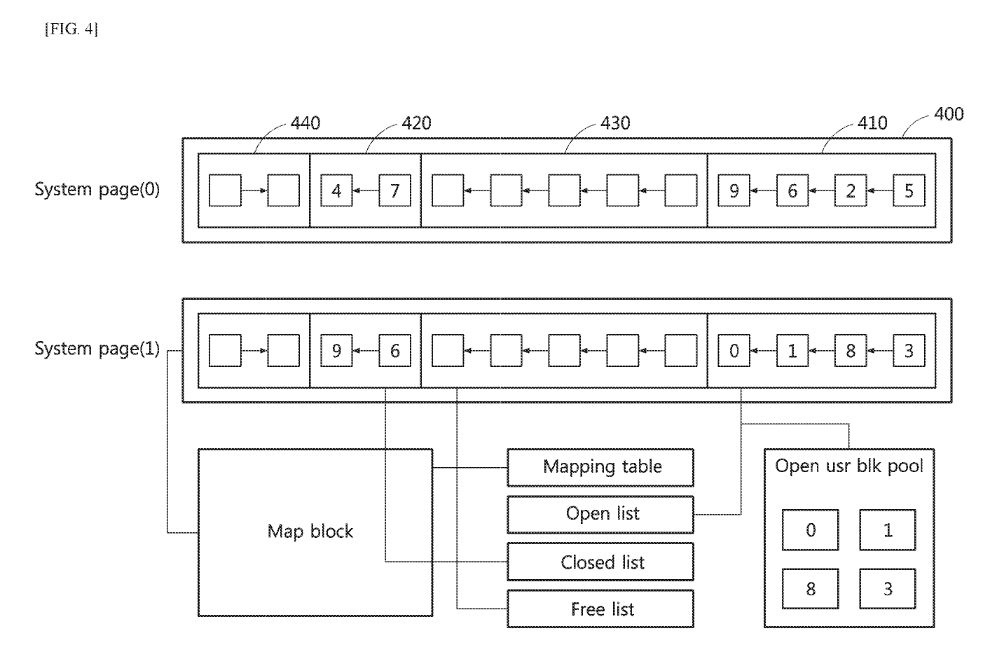

FIG. 4 is a view illustrating a configuration of a system page according to an exemplary embodiment of the present invention.

The controller 110 may identify a map block in which the mapping table is stored and a user block which is being used immediately before the abnormal termination to recover the mapping table after abnormal power loss. Further, in order to identify latest information of data stored in the user block, it is required to sort all the user blocks in an allocated order.

The present invention suggests a method for dramatically shortening a time to identify a user block which is being used immediately before the abnormal termination and a time to sort all the user blocks in an allocated order. In the present invention, the controller 110 suggests a method for dramatically shortening the identifying time and the sorting time using the system page 400.

The system page 400 may include a first user block list 410, a second user block list 420, and a third user block list 430. The flash memory 130 includes free user blocks which are empty to write data. The controller 110 may determine user blocks scheduled to write data in the future, among the free user blocks. In this case, the user blocks scheduled to write data in the future may be defined as first user blocks. An open list of FIG. 4 may correspond to the first user block.

For example, the controller 110 may determine the first user block based on a number of rewriting times of the user blocks. A number of rewritable times of the flash memory 130 is fixed. When the data is rewritten as many as the number of rewritable times, the flash memory may not be used any more. Therefore, the controller 110 manages the number of rewriting times of the user blocks and a user block having a small number of rewriting times may be determined as the first user block. In this case, the controller 110 may store the writing order information for the determined first user blocks in the first user block list 410 of the system page 400.

Further, the controller 110 may define the user blocks in which data is written as a second user block. A closed list of FIG. 4 may correspond to the second user block. In this case, the controller 110 may store the writing order information for the second user blocks in the second user block list 420 of the system page 400. Even though the second user block list 420 of FIG. 4 includes two user blocks, more second user block lists 420 may be stored using an idle space of the system page.

The controller 110 may define free user blocks which are empty to write data excluding the first user block and the second user block, as a third user block. A free list of FIG. 4 may correspond to the third user block. In this case, the controller 110 may store writing order information for the third user blocks in the third user block list 430 of the system page 400. The controller 110 may determine the first user block list 410 which will be stored in the system page 400 which will be formed later, using the third user block list 430.

For example, in FIG. 4, there is a system page 0. The system page 0 includes writing order information for the first user blocks so that the controller 110 stores data in the order of a user block No. 5, a user block No. 2, a user block No. 6, and a user block No. 9, similarly to the first user block list 410. In this case, it is understood that a user block No. 4 and a user block N.7 which are stored in the second user block list 420 are user blocks in which data is already written.

When data is stored in all the user blocks included in the first user block list 410, the controller 110 may store a mapping table for the first user blocks in a page of the map block. Thereafter, as illustrated in FIG. 4, the controller 110 may allocate a new system page 1 and store order information for the first user blocks which are scheduled to write data, like the system page 0. In FIG. 4, the controller 110 may store the writing order information for the first user blocks in the system page 1 so as to store data in the order of a user block No. 3, a user block No. 8, a user block No. 1, and a user block No. 0. Further, the controller 110 may update the writing order information for the user blocks in which the data is already stored through the system page 0, in the second user block list 420.

In the meantime, the controller 110 may also store the writing order information for map blocks scheduled to write a mapping table in the future, in the map block list 440 of the system page 400.

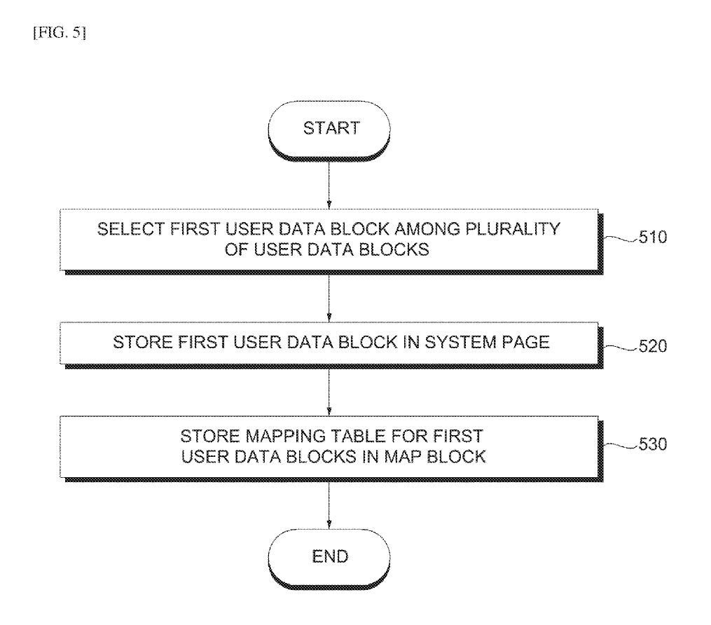

FIG. 5 is a view illustrating a memory managing method according to an exemplary embodiment of the present invention.

In step 510, the controller 110 may determine first user blocks scheduled to write in the future, among a plurality of user blocks in which data will be written. In this case, there are various methods to determine the first user blocks by the controller 110. For example, the controller 110 manages the number of rewriting times of the plurality of user blocks in which data will be written to determine a user block having the smallest number of rewriting times as a first user block.

In step 520, the controller 110 may store writing order information for the determined first user blocks in the system page in the system block. That is, the controller 110 may determine user blocks which write data later using the writing order information for the first user blocks stored in the system page.

Separately from this, the controller 110 may store writing order information for second user blocks in which the data is currently written, among the plurality of user blocks, in the system page of the system block. That is, the controller 110 may identify user blocks in which data has been written so far through the second user block list 420.

Further, the controller 110 may determine free user blocks which are empty to write data excluding the first user block and the second user block among the plurality of user blocks, as third user blocks. The third user block means a user block which is capable of writing data, but is not determined as the first user block, by the controller 110.

The controller 110 may determine map blocks scheduled to write a mapping table in the future, among the plurality of map blocks in which a mapping table will be written. The controller 110 may store writing order information for the determined map blocks in the system page of the system block. That is, the controller 110 may determine map blocks which write a mapping table later using the writing order information for the map blocks stored in the system page.

In step S530, when data is written in all the first user blocks corresponding to the writing order information for the first user blocks stored in the system page, the controller 110 may store a mapping table for the first user blocks stored in the cache memory 120 in a map page of the map block. In this case, since a mapping table for the first user blocks among the entire mapping tables is changed, the controller 110 may store only the changed mapping table for the first user blocks in the map page of the map block.

Next, the controller 110 may newly allocate a system page and determine user blocks scheduled to write in the future, among the third user blocks, as a new first user block. The controller 110 may store writing order information for the new first user blocks in the system page of the system block.

Separately from this, the controller 110 may update the writing order information for second user blocks of the newly allocated system page using the writing order information for the first user blocks in which data is written through steps 510 to 530.

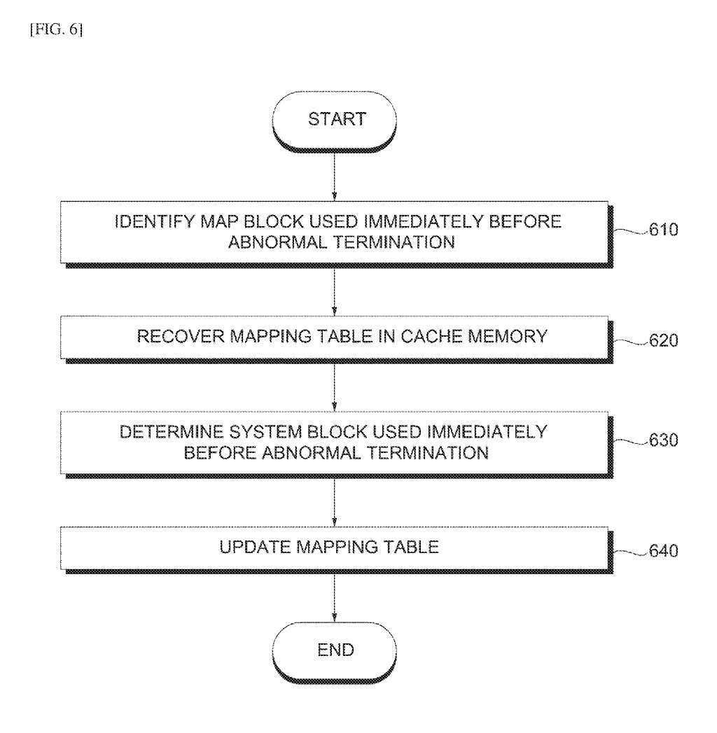

FIG. 6 is a view illustrating a method for determining a number of first user blocks according to an exemplary embodiment of the present invention.

The controller 110 may determine first user blocks scheduled to write data, among a plurality of user blocks in which data will be written, based on a recovery time of the mapping table required by the user. When data is written in the first user blocks, the controller 110 may write the mapping table in the spare area and the last page of the first user blocks. In this case, the mapping table which is written in the spare area and the last page of the first user blocks may be represented as a first mapping table.

When data is written in all the first user blocks, the controller 110 may switch the first user blocks into second user blocks in which data is completely written. In this case, the controller 110 may sequentially write mapping tables for the second user blocks switched from the first user blocks, in a map block and represent the mapping table as a second mapping table. The second mapping table may be written in the form of a snap shot.

In this case, the first user blocks may be determined based on a recovery time of the mapping table required by the user. For example, when it is assumed that the recovery time of the mapping table required by the user is 5 seconds, it is adjusted to recover the mapping table from the first user blocks as many as possible within a given time. Since the mapping table information is sequentially stored in the map block, the mapping table may be immediately replaced.

For example, as illustrated in FIG. 6, the second mapping table may be quickly recovered within approximately 0.5 seconds using the map block. By doing this, it is possible to calculate how many first user blocks may be used to recover the mapping table during the remaining 4.5 seconds of the mapping table recovery time of 5 seconds, which is required by the user. In this case, it is assumed that the first user block in which data is stored in all the pages thereof separately has a page which stores the mapping table so that a recovery delay time of approximately 1 second is necessary and a delay time of approximately 1.5 second is necessary for other data block. Therefore, the controller 110 may recover the mapping table from four first user blocks for a limited time of 4.5 seconds.

That is, the controller 110 stores the mapping table for four first user blocks in the map block after determining four first user blocks from the plurality of user blocks to store data so that a recovery time of the mapping table of 5 seconds which is required by the user may be satisfied.

When it is assumed that the recovery time of the mapping table required by the user is 4 seconds, the controller 110 stores the mapping table for three first user blocks in the map block after determining three first user blocks from the plurality of user blocks to store data so that a recovery time of the mapping table which is required by the user may be satisfied. However, in this case, the mapping table may be more frequently stored in the map block as compared with the related art, so that writing delay and durability reduction may be more significant.

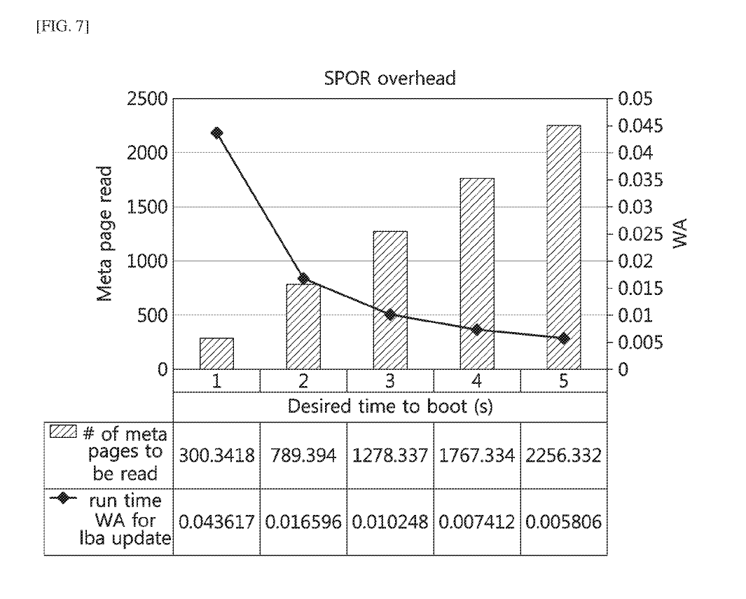

FIG. 7 is a view illustrating the number of user blocks which can be recovered for every recovery time of a mapping table required by a user according to an exemplary embodiment of the present invention.

The number of user blocks which may be recovered for every recovery time of the mapping table required by the user is a theoretical value calculated by assuming many parts. Here, a time to recover the entire mapping table from the map block to the cache memory 120 is approximately 0.4 seconds. When the mapping table recovery time required by the user is 1 second, since a time to recover the second mapping table from the map block is 0.4 seconds, the controller 110 may recover the first mapping table from the first user blocks for 0.6 seconds. As a result, it is confirmed that the controller 110 may recover the first mapping table from 300 first user blocks.

In this case, it is confirmed that when the data is written in all of 300 first user blocks, the controller 110 performs an operation of writing a mapping table for 300 first user blocks in the map block and thus approximately 4% of rewriting overhead is incurred.

Differently from this, when the mapping table recovery time required by the user is 5 seconds, since a time to recover the second mapping table from the map block is 0.4 seconds, the controller 110 may recover the first mapping table from the first user blocks for 4.6 seconds. As a result, it is confirmed that the controller 110 may recover the first mapping table from 2256 first user blocks.

In this case, it is confirmed that when the data is written in all the 2256 first user blocks, the controller 110 performs an operation of writing a mapping table for 2256 first user blocks in the map block and thus approximately 0.5% of rewriting overhead is incurred.

As seen from the above result, it is understood that a trade-off relationship is established between a frequency of writing the mapping table in the map block and a time to reboot the system after the abnormal power loss. The present invention determines the number of first user blocks based on the mapping table recovery time required by the user to flexibly determine a frequency of writing the mapping table in the map block.

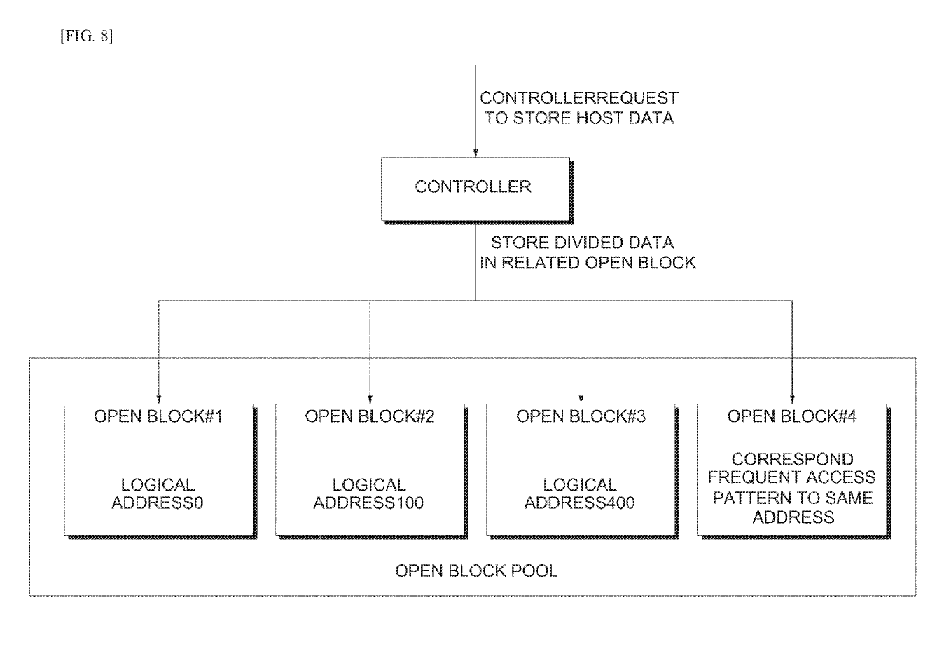

FIG. 8 illustrates a method of storing data to be divided in a related open block, according to an exemplary embodiment of the present invention.

In the present invention, the controller 110 may determine first user blocks scheduled to write data in the future, among a plurality of user blocks in which data will be written. In this case, the plurality of determined first user blocks may be represented as open blocks and the controller 110 may divide data transmitted through a host system according to a type of locality to be written in the open blocks.

When a restricted open block is used similarly to the related art, data having different localities is highly likely to be mixed and stored in one open block. That is, when a data group which is frequently changed and a fixed data group are mixed in one open block, the fixed data group unnecessarily moves to another open block at the time of garbage collection, so that an overhead may be incurred.

In the present invention, the controller 110 identifies whether data transmitted through a host system has a temporal locality or a spatial locality and sequentially writes the data in a plurality of pages included in one open block among open blocks based on the identified locality.

First, when the data needs to be repeatedly written in a specific logical address during a predetermined time interval, the controller 110 may identify that the data has the temporal locality. For example, in the case of programs which are repeatedly called and used such as iterative loop program or subroutine programs, writing access may be very frequently generated in a specific logical address area during a short time interval. In this case, when the time interval is defined and all the accesses to a specific logical address generated during the same time interval are processed in one open block, almost all pages existing in one open block at the moment of garbage collection is highly likely to be invalidated. Therefore, when it is identified that the data has a temporal locality, the controller 110 collectively writes data in any one open block among the plurality of user blocks so that the number of pages in the open block to which may be moved at the time of garbage collection is reduced. Therefore, the performance and the durability of the storage apparatus may be improved.

Second, when the data needs to be written in a similar logical address area, the controller 110 may identify that the data has a spatial locality. For example, a multimedia file or fixed files of a program such as an operating system OS are stored in a specific logical address area and then moved or deleted at once. Therefore, when the files are collected and stored in one open block, it is effective for the garbage collection. Therefore, when it is identified that the data has a spatial locality, the controller 110 may sequentially write data in a plurality of pages included in any one open block among a plurality of open blocks.

Third, the controller 110 may effectively process a writing access to a storage apparatus of a host system which supports a multi-process and multi-thread. With respect to the host system having one process or one thread, the controller 110 sequentially stores one data connected to a logical address area in the open block, but simultaneously several data in the open block due to the host system which supports the multi-process and the multi-thread in recent years. In this case, the data is divided in a time-divisional manner and the divided data is transmitted to each of the processors and the threads so that consequently, no-sequential data pattern may be generated.

Therefore, the controller 110 collectively writes the divided data in any one open block among the plurality of open blocks based on the spatial locality according to the processor unit or the thread unit, so that the performance and the durability of the storage apparatus may be improved.

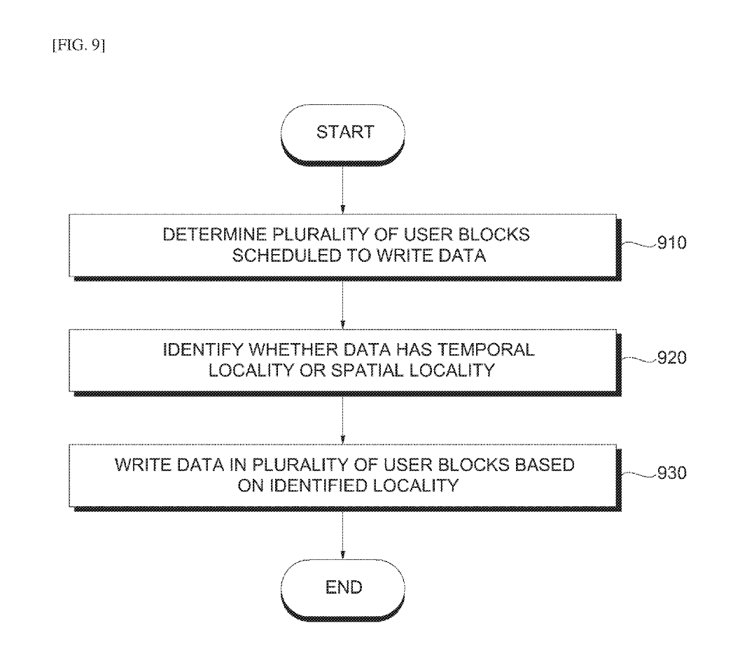

FIG. 9 illustrates a method of writing data in an open block according to an exemplary embodiment of the present invention.

In step 910, the controller 110 of the memory storage apparatus 100 may determine a plurality of first user blocks scheduled to write data, among a plurality of user blocks in which data will be written. In this case, the plurality of determined first user blocks may be represented as open blocks. The open block refers to a user block in which the controller 110 actually performs a writing operation during the operation. When data is written in all the pages in the user block, the open block is changed into a closed block.

When the data which is scheduled to be written in the determined open blocks is transmitted through the host system, the controller 110 may identify whether the data has a temporal locality or a spatial locality in step 920.

When the data needs to be repeatedly written in a specific logical address during a predetermined time interval, the controller 110 may identify that the data has the temporal locality. Further, when the data needs to be written in a similar logical address area, the controller 110 may identify that the data has a spatial locality.

In step 930, the controller 110 may write the data in a plurality of open blocks based on the identified locality of the data. When it is identified that the data has a temporal locality, the controller 110 may collectively write data in any one open block among a plurality of open blocks.

Alternatively, when it is identified that the data has a spatial locality, the controller 110 may collectively write data in any one open block among a plurality of open blocks. In this case, the controller 110 may sequentially write the data in a plurality of pages included in the open block.

When it is identified that the data has the spatial locality, the controller 110 divides the data according to the multi-process or the multi-thread of the host system and collectively write the divided data in any one open block among the plurality of open blocks according a process unit or a thread unit.

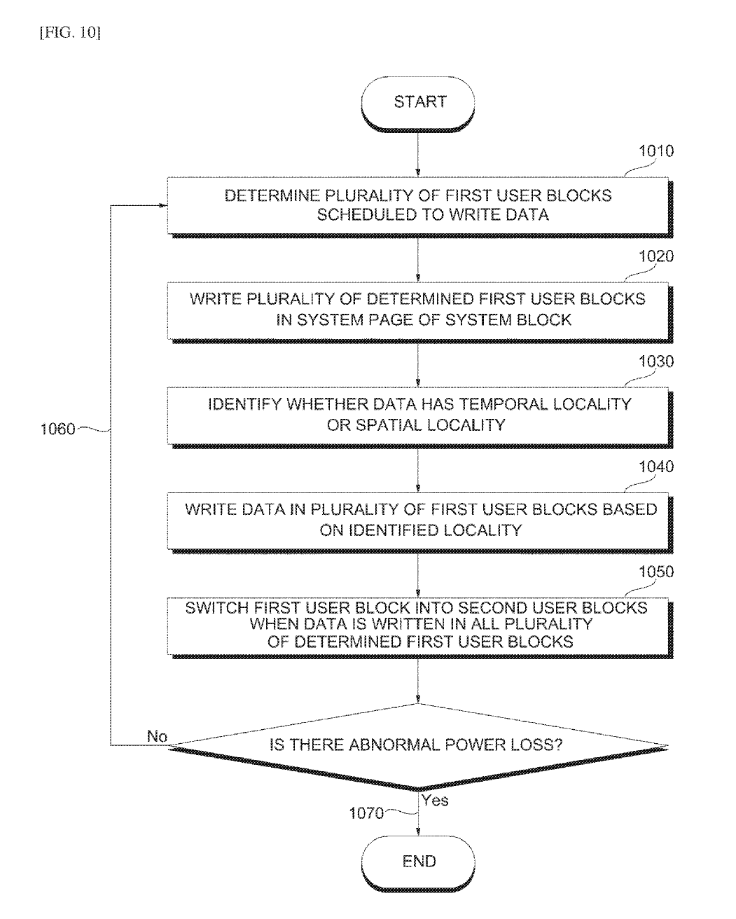

FIG. 10 illustrates a method of writing data in an open block managed by a system page according to an exemplary embodiment of the present invention.

In step 1010, the controller 110 may determine a plurality of first user blocks scheduled to write data, among a plurality of user blocks in which data will be written. In this case, the plurality of determined first user blocks may be represented as open blocks.

In step 1020, the controller 110 may store information on the open blocks determined in step 1010 in the system page of the system block.

When the data which is scheduled to be written in the open blocks determined in step 1010 is transmitted through the host system, the controller 110 may identify whether the data has a temporal locality or a spatial locality in step 1030.

When the data needs to be repeatedly written in a specific logical address during a predetermined time interval, the controller 110 may identify that the data has the temporal locality. Further, when the data needs to be written in a similar logical address area, the controller 110 may identify that the data has a spatial locality.

In step 1040, the controller 110 may write the data in a plurality of open blocks based on the identified locality of the data. When it is identified that the data has a temporal locality, the controller 110 may collectively write data in any one open block among a plurality of open blocks.

Alternatively, when it is identified that the data has a spatial locality, the controller 110 may collectively write data in any one open block among a plurality of open blocks. In this case, the controller 110 may sequentially write the data in a plurality of pages included in the open block.

When it is identified that the data has the spatial locality, the controller 110 divides the data according to the multi-process or the multi-thread of the host system and collectively write each of the divided data in any one open block among the plurality of open blocks according a process unit or a thread unit.

In step S1050, when the data is written in all the determined open blocks, the controller 110 may switch the open blocks into a second user block to store related information in a second user block list 420 of the system page. In this case, the second user block list 420 may correspond to the closed list of FIG. 4.

Thereafter, when abnormal power loss does not occur in the host system, the controller 110 may determine new open blocks and write data in step 1060. Alternatively, when abnormal power loss occurs in the host system, the controller 110 may recover the mapping table in step S1070.

As described above, in the present invention, several open blocks are used so that flexibility is secured in an algorithm such as a flash translation layer (FTL) or a garbage collection to improve a performance and a durability of the memory storage apparatus 100.

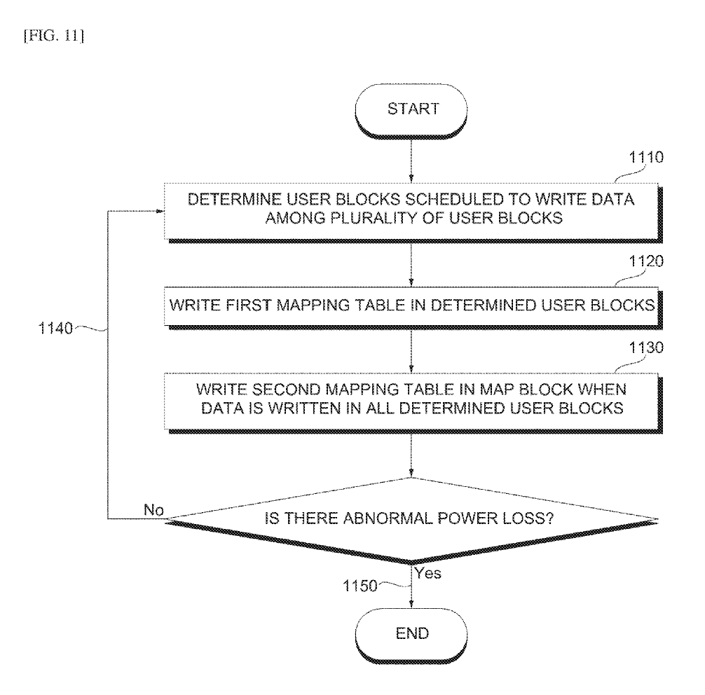

FIG. 11 is a view illustrating a mapping table writing method according to an exemplary embodiment of the present invention.

In step 1110, the controller 110 of the memory storage apparatus 100 may determine first user blocks scheduled to write data, among a plurality of user blocks in which data will be written, based on the recovery time of the mapping table required by the user. In this case, the memory controller 110 may determine the number of first user blocks which satisfies the recovery time of the mapping table required by the user using a recovery time for the first mapping table written in the first user blocks and a recovery time for the second mapping table written in the map block. The controller 110 may store order information of the determined first user blocks in the system page of the system block.

In step S1120, the controller 110 may write the first mapping table for the determined first user blocks. In this case, the controller 110 may write the first mapping table in a spare area of each page included in the first user blocks. Further, the controller 110 may collectively write all the mapping tables written in the spare area of the pages of the spares in the last page included in the first user block.

When the data is written in all the determined first user blocks, the controller 110 switches the determined first user blocks into second user blocks in which data is completely written and write the second mapping table for the switched second user blocks in the map block in step 1130.

When the abnormal power loss does not occur, the controller 110 may determine new first user blocks to write data therein in step 1140.

When the abnormal power loss occurs, the controller 110 may recover the mapping table to the cache memory 120 in step 1150.

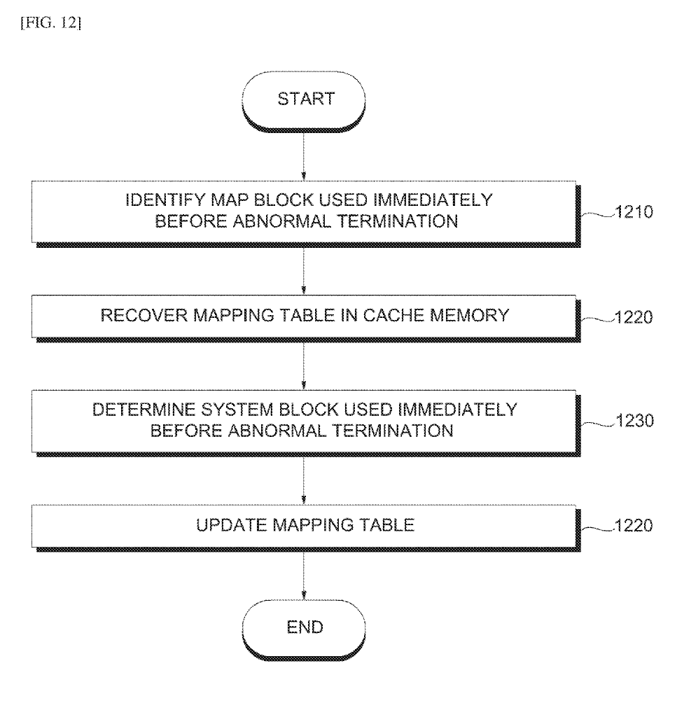

FIG. 12 is a view illustrating a mapping table recovering method according to an exemplary embodiment of the present invention.

In step 1210, the controller 110 may identify a map block which is immediately before the abnormal termination, among the plurality of map blocks. First page information of each of the plurality of map blocks may include allocating order information of the corresponding map blocks at the time of allocating and using the map blocks. Further, last page information of each of the plurality of map blocks may include identification information for identifying whether the corresponding map blocks are deleted when all the pages of the map blocks are used.

The controller 110 may identify the map block which is used immediately before the abnormal power loss using the first page information and the last page information of each of the plurality of map blocks.

In step 1220, the controller 110 may recover the second mapping table stored in the map page of the map block identified in step 1210. Since the second mapping table for the second user blocks is written in the map block in the form of a snap shot, it is possible to recover the second mapping table to the cache memory 120 within a comparatively short time.

For example, it is assumed that abnormal power loss occurs during a process of storing data in the user block by the system page 1 illustrated in FIG. 4. The controller 110 may recover the mapping table stored in the map page of the identified map block. In this case, as the mapping table which is transmitted to the cache memory 120 by the controller 110, a mapping table for the first user blocks stored in the system page 0 is also stored. That is, the mapping table stored in the map page of the map block identified by the controller 110 still lacks latest information.

Therefore, the controller 110 updates the mapping table for the first user blocks stored in the system page 1 which is being used immediately before the abnormal power loss to the cache memory 120 to recover the latest mapping table.

To this end, the controller 110 may determine the system block which is used immediately before the abnormal power loss in step 1230. In this case, the controller 110 may use the same method as step 1210. That is, the controller 110 may identify the system block used immediately before the abnormal power loss by searching the first page and the last page of the plurality of system blocks.

In step 1240, the controller 110 may update the recovered mapping table in the cache memory 120 using the system block used immediately before the abnormal power loss, which is determined in step 1230.

Specifically, the controller 110 may identify the system page which is used at last among the system blocks used immediately before the abnormal power loss. In this case, the controller 110 may determine the first user block used immediately before the abnormal power loss using information on the first user blocks stored in the identified system page. In this case, the controller 110 may determine the first user block used immediately before the abnormal power loss by searching the first page information and the last page information of the first user blocks.

The controller 110 may modify the mapping table stored in the cache memory 120 using the first user block information used immediately before the abnormal power loss. In this case, the controller 110 may determine whether data is written in all the first user blocks, using the first page information and the last page information of each of the first user blocks.

When data is written in all the first user blocks, the controller 110 may recover the first mapping table using the last page of the first user block. In contrast, when the data is not written in all the first users, the controller 110 may recover the first mapping table using the spare area of the first user block.

Therefore, during the process of rebooting the system after the abnormal power loss, the controller 110 uses the system page including the writing order information for the first user blocks, to more quickly recover the latest mapping table. This is because the number of user blocks which need to be searched may be reduced and a time to sort the user blocks may be shortened through the writing order information for the first user blocks stored in the system page during a process of finding the user block used immediately before the abnormal power loss.

The method according to the exemplary embodiment of the present invention may be implemented as a program command which may be executed by various computers to be written in a computer readable medium. The computer readable medium may include solely a program command, a data file, a data structure, and the like, or a combination thereof. The program command written in the medium may be specifically designed or constructed for the present invention or known to those skilled in the art of a computer software to be used.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Therefore, the scope of the present invention should not be defined by being limited to the examples described, but should be defined by the claims to be described below and those equivalent to the claims.

1. A memory storing method, comprising:
determining a plurality of first user blocks scheduled to write data among a plurality of user blocks in which data will be written, based on a recovery time of a mapping table required by a user;
storing writing order information for the determined first user blocks in a system page of a system block;
writing data in first user blocks corresponding to the writing order information;
writing a first mapping table in a spare area and a last page of the first user blocks in which the data is written; and
switching the first user blocks written in the system page into second user blocks in which the data is completely written when data is written in all the first user blocks and writing a second mapping table for the switched second user blocks in a map page of a map block.

2. The memory storing method of claim 1, wherein in the determining, the number of first user blocks which satisfies the recovery time of the mapping table required by the user is determined using a recovery time for the first mapping table written in the first user blocks and a recovery time for the second mapping table written in the map block.

3. The memory storing method of claim 1, wherein the writing of data in the first user blocks includes:
identifying whether the data has a temporal locality or a spatial locality when data scheduled to be written in the first user blocks is transmitted through a host system; and
writing the data in the first user blocks based on the identified locality of data.

4. The memory storing method of claim 3, wherein in the identifying, when the data needs to be repeatedly written in a specific logical address during a predetermined time interval, it is identified that the data has a temporal locality; and when the data needs to be written in a similar logical address area, it is identified that the data has a spatial locality.

5. The memory storing method of claim 3, wherein in the writing of the data in the first user blocks based on the identified locality of data, when it is identified that the data has the spatial locality, the data is sequentially written in a plurality of pages included in any one user block among the plurality of user blocks.

6. The memory storing method of claim 1, wherein in the writing of the data in the first user blocks based on the identified locality of data, when it is identified that the data has the temporal locality, the data is collectively written in any one user block among the plurality of user blocks.

7. The memory storing method of claim 1, wherein in the writing of the data in the first user blocks based on the identified locality of data, when it is identified that the data has a spatial locality, the data is divided according to a multi-process or a multi-thread of a host system and each of the divided data is collectively written in any one user block among the plurality of user blocks according to a process unit or a thread unit.

8. A memory recovering method, comprising:
identifying a map block which is used immediately before abnormal power loss, among a plurality of map blocks;
recovering a second mapping table stored in a map page of the identified map block to a cache memory;
determining a system block used immediately before the abnormal power loss, among a plurality of system blocks; and
updating a first mapping table using information on first user blocks stored in a system page of the determined system block.

9. The memory recovering method of claim 8, wherein in the identifying, the map block which is used immediately before the abnormal power loss is identified using first page information and last page information of each of the plurality of map blocks.

10. The memory recovering method of claim 9, wherein the first page information of each of the plurality of map blocks includes allocating order information of the map block at the time of allocating and using the map block, and the last page information of each of the plurality of map blocks includes information for identifying whether the map block is deleted when all the pages of the map block are used.

11. The memory recovering method of claim 8, wherein in the determining, the system block which is used immediately before the abnormal termination is determined using first page information and last page information of each of the plurality of system blocks.

12. The memory recovering method of claim 11, wherein the first page information of each of the plurality of system blocks includes allocating order information of the system block at the time of allocating and using the system block, and the last page information of each of the plurality of system blocks includes information for identifying whether the system block is deleted when all the pages of the system block are used.

13. The memory recovering method of claim 8, wherein in the updating, when data is written in all pages of the first user block among the first user blocks stored in the identified system block, the first mapping table is recovered to a cache memory using the last page of the first user block and when data is not written in all pages of the first user block, the first mapping table is recovered to the cache memory using a spare area of the first user block.

14. A memory storage apparatus, comprising:
a controller which performs a plurality of operations,
wherein the plurality of operations includes:
an operation of determining a plurality of first user blocks scheduled to write data among a plurality of user blocks in which data will be written, based on a recovery time of a mapping table required by a user;
an operation of storing writing order information for the determined first user blocks in a system page of a system block;
an operation of writing data in first user blocks corresponding to the writing order information;
an operation of writing a first mapping table in a spare area and a last page of the first user blocks in which the data is written; and
an operation of switching the first user blocks written in the system page into second user blocks in which the data is completely written when data is written in all the first user blocks and writing a second mapping table for the switched second user blocks in a map page of a map block.

15. The memory storage apparatus of claim 14, wherein the controller determines the number of first user blocks which satisfies the recovery time of the mapping table required by the user using a recovery time for the first mapping table written in the first user blocks and a recovery time for the second mapping table written in the map block.

16. The memory storage apparatus of claim 14, wherein when the data scheduled to be written in the first user blocks is transmitted through a host system, the controller identifies whether the data has a temporal locality or a spatial locality and writes the data in the first user blocks based on the identified locality of data.

17. The memory storage apparatus of claim 14, wherein when the data needs to be repeatedly written in a specific logical address during a predetermined time interval, the controller identifies that the data has a temporal locality and when the data needs to be written in a similar logical address area, the controller identifies that the data has a spatial locality.

18. The memory storage apparatus of claim 14, wherein when it is identified that the data has the spatial locality, the controller sequentially writes the data in a plurality of pages included in any one user block among the plurality of user blocks.

19. The memory storage apparatus of claim 14, wherein when it is identified that the data has the temporal locality, the controller collectively writes data in any one user block among the plurality of user blocks.

20. The memory storage apparatus of claim 14, wherein when it is identified that the data has a spatial locality, the controller divides the data according to a multi-process or a multi-thread of a host system and collectively writes the divided data in any one user block among the plurality of user blocks according to a process unit or a thread unit.

21. A memory recovering apparatus, comprising:
a controller which performs a plurality of operations,
wherein the plurality of operations includes:
an operation of identifying a map block which is used immediately before abnormal power loss, among a plurality of map blocks;
an operation of recovering a second mapping table stored in a map page of the identified map block to a cache memory;
an operation of determining a system block used immediately before the abnormal power loss, among a plurality of system blocks; and
an operation of updating a first mapping table using information on first user blocks stored in a system page of the determined system block.

22. The memory recovering apparatus of claim 21, wherein the controller identifies the map block which is used immediately before the abnormal termination using first page information and last page information of each of the plurality of map blocks.

23. The memory recovering apparatus of claim 22, wherein the first page information of the plurality of map blocks includes allocating order information of the map block at the time of allocating and using the map block, and the last page information of each of the plurality of map blocks includes information for identifying whether the map block is deleted when all the pages of the map block are used.

24. The memory recovering apparatus of claim 21, wherein the controller identifies the system block which is used immediately before the abnormal termination using first page information and last page information of each of the plurality of system blocks.

25. The memory recovering apparatus of claim 24, wherein the first page information of the plurality of system blocks includes allocating order information of the system block at the time of allocating and using the system block, and the last page information of each of the plurality of system blocks includes information for identifying whether the system block is deleted when all the pages of the system block are used.

26. The memory recovering apparatus of claim 21, wherein when data is written in all pages of the first user block among the first user blocks stored in the identified system block, the controller recovers the first mapping table to a cache memory using the last page of the first user block and when data is not written in all pages of the first user block, the controller recovers the first mapping table to the cache memory using a spare area of the first user block.
